(19) United States
(12) Patent Application Publication
(10) Pub. No.: US 2015/0046394 A1
(43) Pub. Date: Feb. 12, 2015

(54) STORAGE SYSTEM, STORAGE CONTROL DEVICE, AND STORAGE MEDIUM STORING CONTROL PROGRAM

(71) Applicant: FUJITSU LIMITED, Kawasaki-shi (JP)

(72) Inventors: Yasuhiro Onda, Kawasaki (JP); Yoichi YASUFUKU, Machida (JP); Norikatsu Sasakawa, Yokohama (JP); Noboru Osada, Yamato (JP); Suijin Taketa, Kawasaki (JP)

(21) Appl. No.: 14/319,461

(22) Filed: Jun. 30, 2014

(30) Foreign Application Priority Data
Aug. 7, 2013 (JP) 2013-164452

(51) Int. Cl. G06F 17/30

(52) U.S. Cl. CPC G06F 17/30203; G06F 17/30578
USPC 707/623

(57) ABSTRACT

When a master name node has created a file, the master name node performs meta-information synchronization with only a slave name node, and does not perform the meta-information synchronization with a dummy name node. The master name node performs the meta-information synchronization with the dummy name node asynchronously with file creation. Furthermore, the slave name node stores the same meta-information as that stored in the master name node, and the file is stored in a data node placed in the same node as the slave name node and a data node placed in the same node as the master name node.

### CROSS-REFERENCE TO RELATED APPLICATION(S)

This application is based upon and claims the benefit of priority of the prior Japanese Patent Application No. 2013-164452, filed on Aug. 7, 2013, the entire contents of which are incorporated herein by reference.

### FIELD

The embodiment discussed herein is related to a storage system, a storage control device, and a storage medium storing a control program.

### BACKGROUND

In recent years, there is increasing use of a distributed file system that operates multiple file servers in the same manner as one file server and allows access to a file via multiple computer networks. The distributed file system enables multiple users to share files and storage resources on multiple machines. As a utility form of such a distributed file system, previously, multiple file servers in the same building or the same site are virtually integrated into one file server; nowadays, a form of wide-area deployment of file servers on a global scale is becoming widespread.

A distributed file system is constructed of a global name space and a file system. The global name space is for integrating respective file name spaces separately managed by file servers into one to realize a virtual file name space, and is a core technology for distributed file systems. The distributed file system is a system that provides a virtual name space created by the global name space to clients.

FIG. 20 is a diagram illustrating a conventional distributed file system. As illustrated in FIG. 20, the conventional distributed file system is composed of a name node 92 and multiple data nodes 93a to 93d; the name node 92 realizes a global name space, and the data nodes 93a to 93d manage actual data.

When a client such as a personal computer (PC) 91d out of clients 91a to 91d accesses a certain file, the client 91d issues a request to the name node 92 (1). Here, assume that files 94a, 94c, and 94d are triplexed by, for example, three data nodes 93a, 93c, and 93d out of the multiple data nodes 93a to 93d.

The name node 92 includes a meta-information storage unit 92a that stores therein meta-information including information on locations of the clients 91a to 91d and locations of the data nodes 93a to 93d, and file information, etc. The name node 92 instructs the data node 93d nearest to the client 91d, which has issued the request, to transfer the file on the basis of the meta-information (2). The data node 93d directly transfers the file to the client 91d on the basis of the instruction from the name node 92 (3).

However, in the case of the distributed file system illustrated in FIG. 20, if the distance between the client 91d and the name node 92 that the client 91d has accessed is far, the process (1) requires time. Accordingly, there has been developed a technology to distribute the function of the name node 92 to multiple nodes.
[Patent document 1] Japanese National Publication of International Patent Application No. 2007-538326

However, when the function of the name node 92 is distributed to multiple nodes, there is a problem that the time taken for meta-information synchronization among name nodes for the maintenance of consistency of the global name space is to be shortened. The maintenance of consistency of the global name space here is to make the meta-information consistent among multiple name nodes.

According to an embodiment, it is possible to shorten the time taken for meta-information synchronization among name nodes.

### SUMMARY

According to an aspect of an embodiment, a storage system in which multiple nodes that each include a storage device and a management device are connected by a network includes, a first management device, out of multiple management devices, that stores, when data has been created, the data in a storage device in a node thereof, and manages an identifier of the data in a manner associated with a storage location of the data in the storage device; and a second management device that receives an instruction to associate information indicating that the data is under the management of the first management device with the identifier of the data from the first management device asynchronously with the time of creation of the data, and manages the information in a manner associated with the identifier.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a distributed file system according to an embodiment;

FIG. 2 is a diagram for explaining meta-information synchronization among name nodes;

FIG. 3 is a block diagram illustrating a functional configuration of a name node according to the embodiment;

FIG. 4A is a diagram illustrating the data structure of meta-information stored in a meta-information storage unit;

FIG. 4B is a diagram for explaining members of metadata;

FIG. 5 is a diagram for explaining file creation by a file creating unit;

FIG. 6 is a diagram for explaining resynchronization among name nodes;

FIG. 7 is a diagram for explaining a process performed by the distributed file system in response to a request for reading of a file to a dummy name node;

FIG. 8 is a diagram illustrating an example of a migration policy;

FIG. 9 is a diagram for explaining a migration process;

FIG. 10 is a diagram for explaining a process for reading of a file to a dummy name node after migration;

FIG. 11 is a diagram for explaining file-copying skipping based on a hash value;

FIG. 12 is a flowchart illustrating the flow of a file creating process;

FIG. 13 is a flowchart illustrating the flow of a resynchronization process;

FIG. 14 is a flowchart illustrating the flow of a file reading process;

FIG. 15 is a flowchart illustrating the flow of the migration process;

FIG. 16 is a flowchart illustrating the flow of an after-migration file reading process;

FIG. 17 is a flowchart illustrating the flow of a master switching process based on a hash value;

FIG. 18 is a flowchart illustrating the flow of an automatic migration process based on access frequency;

FIG. 19 is a diagram illustrating a hardware configuration of a computer that executes a name management program according to the embodiment; and

FIG. 20 is a diagram illustrating a conventional distributed file system.

### DESCRIPTION OF EMBODIMENTS

Preferred embodiments of the present invention will be explained with reference to accompanying drawings. Incidentally, this embodiment does not limit a technology discussed herein.

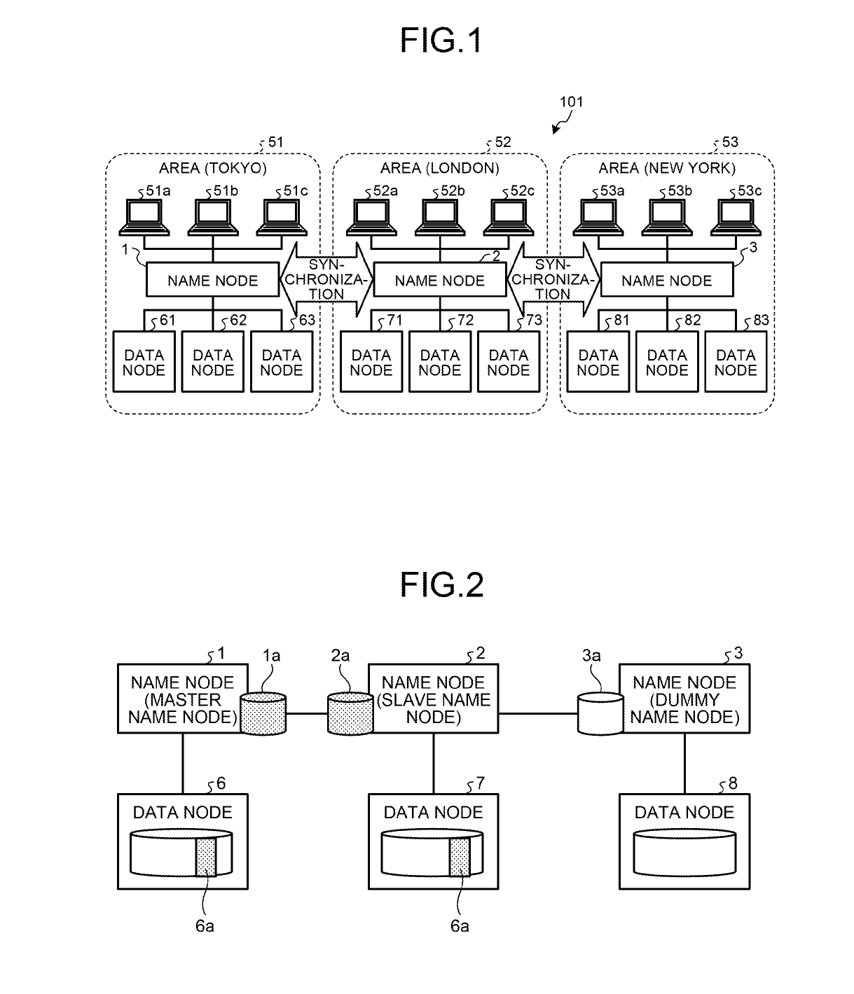

First, a configuration of a distributed file system according to the embodiment is explained. FIG. 1 is a diagram illustrating the configuration of the distributed file system according to the embodiment. As illustrated in FIG. 1, a distributed file system 101 includes name nodes 1 to 3 which are placed in three areas 51 to 53, respectively. For example, the area 51 is Tokyo, the area 52 is London, and the area 53 is New York. Incidentally, in FIG. 1, the name nodes 1 to 3 are connected to one another by a network.

The name nodes 1 to 3 each have meta-information, and manage file names of files in the entire distributed file system 101. Furthermore, data nodes in which files are stored are placed in each area. Specifically, data nodes 61 to 63 are placed in the area 51, data nodes 71 to 73 are placed in the area 52, and data nodes 81 to 83 are placed in the area 53.

Incidentally, here, the name node and the data nodes placed in each area are collectively referred to as a node. For example, the name node 1 and the data nodes 61 to 63 form a node placed in the area 51.

Clients in each area request a name node in the area to allow an access to a file. That is, clients 51a to 51c in the area 51 request the name node 1 to allow a file access, clients 52a to 52c in the area 52 request the name node 2 to allow file access, and clients 53a to 53c in the area 53 request the name node 3 to allow a file access.

Meta-information is synchronized among name nodes. FIG. 2 is a diagram for explaining the meta-information synchronization among name nodes. In FIG. 2, a data node 6 is a node into which the data nodes 61 to 63 are virtually integrated, a data node 7 is a node into which the data nodes 71 to 73 are virtually integrated, and a data node 8 is a node into which the data nodes 81 to 83 are virtually integrated.

FIG. 2 illustrates a case where the name node 1 has received a file create request from a client. When the name node 1 has received a file create request from a client, the name node 1 becomes a master name node of a file requested to be created. The master name node of the file here is a name node that manages the file as a master. Then, the name node 1 instructs the data node 6 to create a file, and the data node 6 creates a file 6a. Furthermore, the name node 1 stores meta-information of the file 6a in a meta-information storage unit 1a.

Then, the name node 1 instructs the nearest name node 2 to create a copy of the file 6a, and the name node 2 as a slave name node creates a file 6a in the data node 7 and stores meta-information of the file 6a in a meta-information storage unit 2a. The slave name node of the file here is a name node that manages the file as a slave subordinate to the master.

In this manner, in the distributed file system 101 according to the embodiment, a file and meta-information are synchronized between a master name node and a slave name node in real time. That is, in the distributed file system 101 according to the embodiment, when a file has been created in a master name node, the file and meta-information of the file are synchronized between the master name node and its slave name node.

On the other hand, when a file has been created in the name node 1, the name node 3 does not create a copy of the file in the data node 8. Like the name node 3, a name node that does not create data in a data node thereof when a file has been created in a master name node is here referred to as a dummy name node that operates as a dummy with respect to the file. Between a dummy name node and a master name node, real-time synchronization of meta-information is not performed, and meta-information synchronization is performed asynchronously with file creation. Furthermore, in the meta-information synchronization performed asynchronously with file creation, the dummy name node acquires only a part of the meta-information from the master name node.

Incidentally, in FIGS. 1 and 2, the distributed file system 101 includes one dummy name node for convenience of explanation; however, the distributed file system 101 can include multiple dummy name nodes. Therefore, the distributed file system 101 does not perform real-time meta-information synchronization between a dummy name node and a master name node; therefore, the number of name nodes that perform real-time synchronization of meta-information can be reduced. Accordingly, the distributed file system 101 can shorten the time required for meta-information synchronization.

Furthermore, FIGS. 1 and 2 illustrate the case of one slave name node; however, the distributed file system 101 can include two or more slave name nodes to increase multiplicity of data.

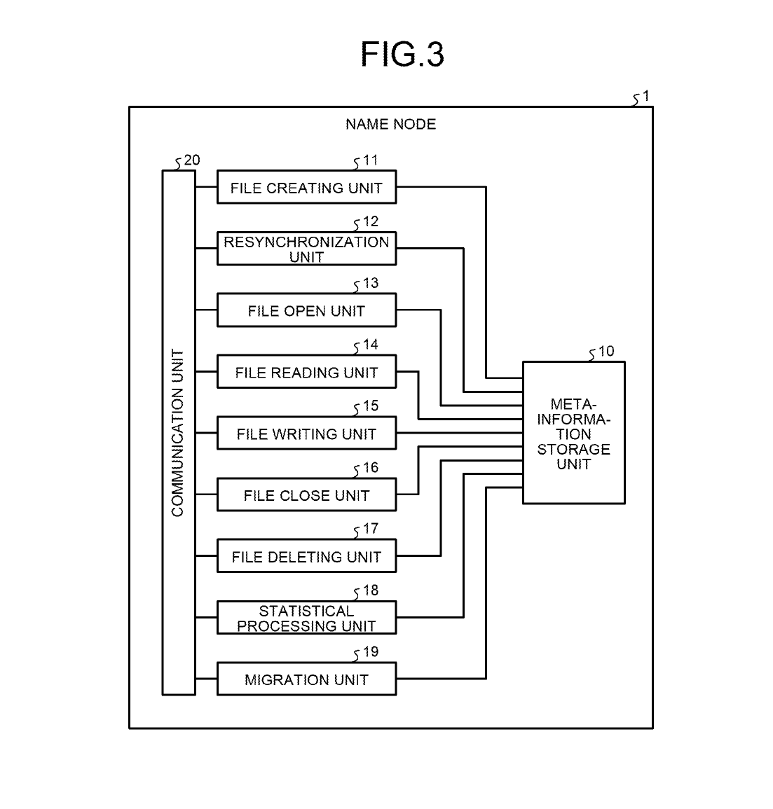

Subsequently, a functional configuration of a name node according to the embodiment is explained. Incidentally, the name nodes 1 to 3 have the same functional configuration, so here we explain a functional configuration of the name node 1 as an example. FIG. 3 is a block diagram illustrating the functional configuration of the name node according to the embodiment.

As illustrated in FIG. 3, the name node 1 includes a meta-information storage unit 10, a file creating unit 11, a resynchronization unit 12, a file open unit 13, a file reading unit 14, a file writing unit 15, a file close unit 16, and a file deleting unit 17. Furthermore, the name node 1 includes a statistical processing unit 18, a migration unit 19, and a communication unit 20.

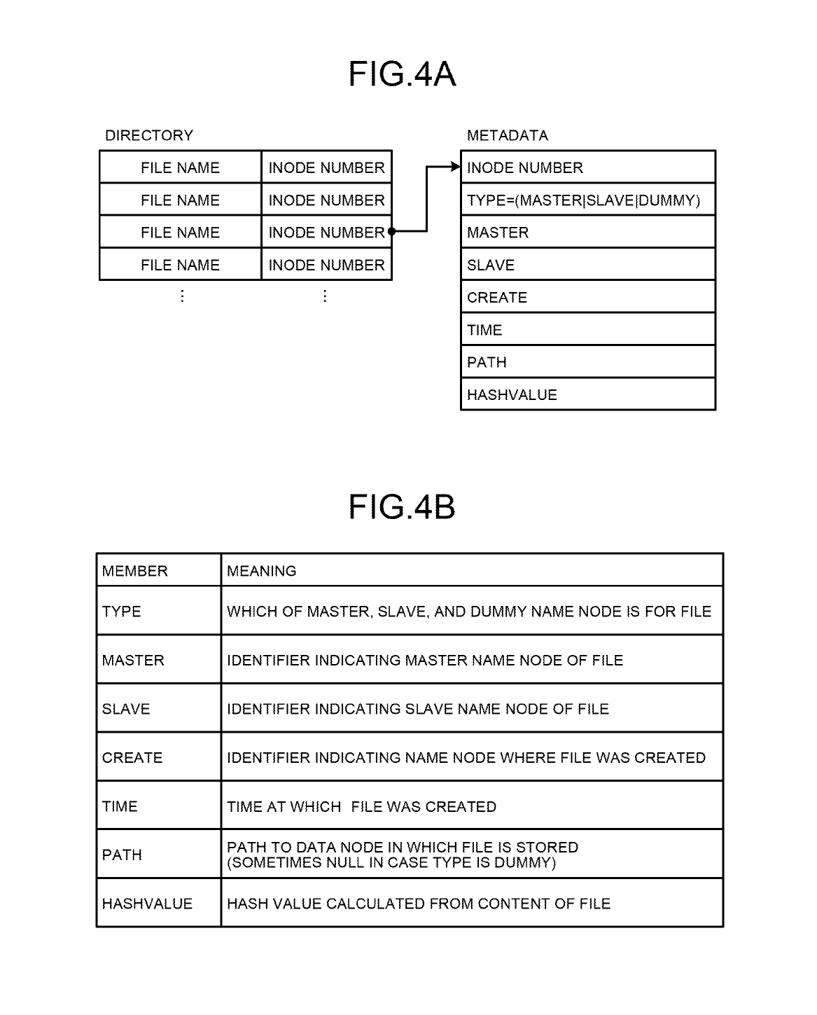

The meta-information storage unit 10 stores therein information that the name node 1 manages, such as meta-information of a file and node location information. FIG. 4A is a diagram illustrating the data structure of meta-information stored in the meta-information storage unit. As illustrated in FIG. 4A, the meta-information includes a directory and metadata. The directory stores therein a file name and an inode number in a corresponding manner with respect to each file. The inode number here is a number of an inode in which metadata on a file is stored.

The metadata includes an inode number, type, master, slave, create, time, path, and hashvalue as members. FIG. 4B is a diagram for explaining members of metadata. As illustrated in FIG. 4B, type indicates which of a master, a slave, and a dummy a name node is for a file. Master indicates a master name node of the file. Slave indicates a slave name node of the file. Create indicates a name node where the file was created. Time indicates the time at which the file was created. Path indicates a path to a data node in which the file has been stored. Hashvalue indicates a hash value calculated from content of the file.

Furthermore, the meta-information storage unit 10 stores therein log information of the file. The log information includes the number of accesses to the file from clients.

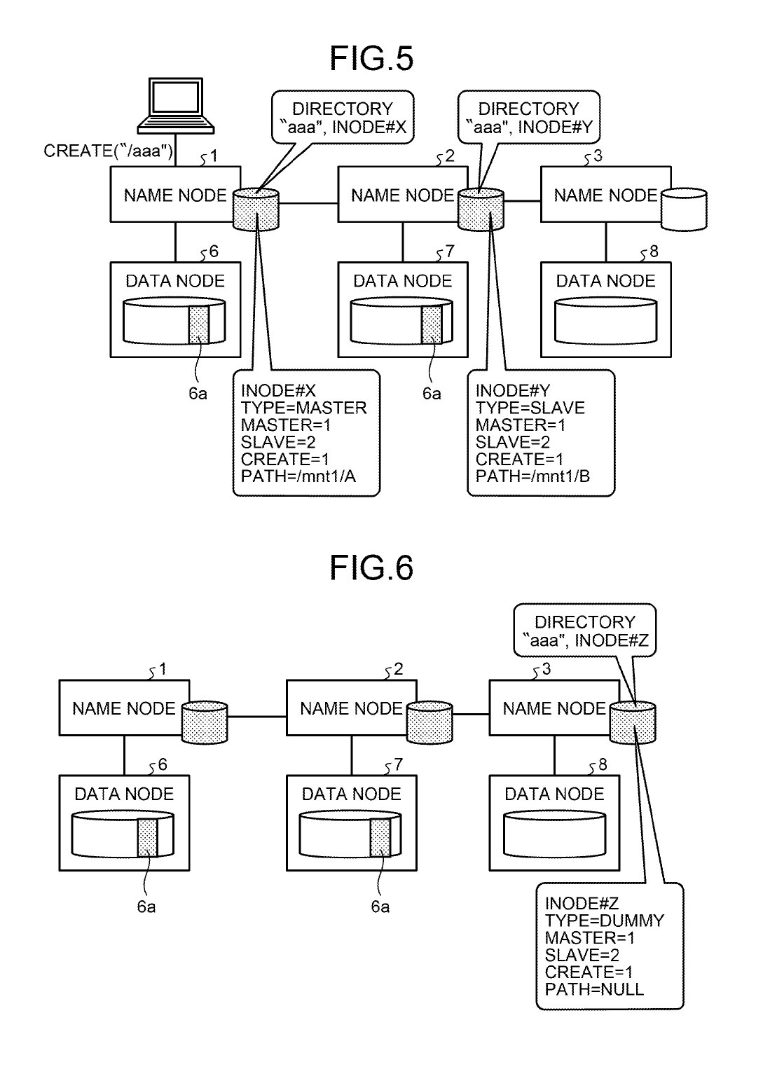

To return to FIG. 3, the file creating unit 11 creates meta-information of a file on the basis of a file create request from a client, and creates the file in a data node of the name node 1. FIG. 5 is a diagram for explaining file creation by the file creating unit 11. In FIG. 5, create(“/aaa”) denotes a request for creation of a file “aaa” from a client. Furthermore, the name nodes 1 to 3 are connected to one another by a network.

As illustrated in FIG. 5, when having received a file create request from the client, the file creating unit 11 of the name node 1 creates an actual file in the data node 6, and instructs the name node 2 to create a slave file. Creating an actual file here is to actually create a file 6a in a disk device. Furthermore, the slave file here is a copy of the file 6a created in a slave name node.

Then, the file creating unit 11 of the name node 1 registers a file name “aaa” in a directory in a manner corresponding to inode#x. Then, the file creating unit 11 creates an inode indicating that an inode number is inode#x, type of the name node 1 is master, master is the name node 1, slave is the name node 2, create is the name node 1, and path is /mnt1/A.

Furthermore, a file creating unit of the name node 2 creates an actual file in the data node 7, and registers a file name “aaa” in a directory in a manner corresponding to inode#y. Then, the file creating unit of the name node 2 creates an inode indicating that an inode number is inode#y, type of the name node 2 is slave, master is the name node 1, slave is the name node 2, create is the name node 1, and path is /mnt1/B.

Incidentally, at this point, the name node 3, which is a dummy name node, does not create meta-information of the file whose file name is “aaa”. When the name node 3 has received an instruction for resynchronization, the name node 3 creates meta-information of the file whose file name is “aaa”. The term “resynchronization” here means synchronization performed between a master and a dummy because synchronization between the master and the dummy is not performed as against synchronization between the master and a slave is performed when a file is created.

Furthermore, to allow a name node to create a file with the same file name as a file which has been created in the name node 1 while meta-information on the file created in the name node 1 has not yet been reflected in another name node, the file is identified by the file name plus create information.

The resynchronization unit 12 performs resynchronization of meta-information among name nodes regularly or on the basis of an instruction from a system administrator. As for a file of which the master is the name node 1, the resynchronization unit 12 instructs a dummy name node to create a dummy; as for a file of which the dummy is the name node 1, the resynchronization unit 12 creates a dummy. Creating a dummy here is to create meta-information of a file in a dummy name node.

FIG. 6 is a diagram for explaining resynchronization among name nodes. FIG. 6 illustrates resynchronization of the file “aaa” illustrated in FIG. 5. As illustrated in FIG. 6, the resynchronization unit 12 of the name node 1, which is a master name node of the file “aaa”, instructs the name node 3 which is a dummy name node to perform resynchronization.

Then, a resynchronization unit of the name node 3 registers a file name “aaa” in a directory in a manner corresponding to inode#z. Then, the resynchronization unit of the name node 3 creates an inode indicating that an inode number is inode#z, type of the name node 3 is dummy, master is the name node 1, slave is the name node 2, create is the name node 1, and path is null. The term “null” here indicates that there is no path to the file. That is, the dummy name node includes only meta-information, and the file is not in an area in which the dummy name node is placed.

In this manner, the resynchronization unit 12 performs resynchronization among name nodes, thereby a dummy name node can recognize a destination to transfer an access request upon request for access to a file of which the dummy is the dummy name node.

The file open unit 13 performs open processing, such as checking whether there is a file, in response to a file open request. When the name node 1 is a master of the file requested to be opened, the file open unit 13 performs open processing on the file in a data node of the name node 1, and instructs a slave name node to open the file. On the other hand, when the name node 1 is not a master of the file requested to be opened, the file open unit 13 transfers the file open request to a master name node, and transmits a response to a requestor on the basis of a response from the master name node.

The file reading unit 14 reads out data from an opened file and transmits the read data to a client. When the name node 1 is a master or slave of the file requested to be read, the file reading unit 14 reads out the file from a data node of the name node 1 and transmits the read file to the client. On the other hand, when the name node 1 is a dummy of the file requested to be read, the file reading unit 14 requests a master name node or a slave name node, whichever is closer to the name node 1, to transfer the file, and transmits the transferred file to the client.

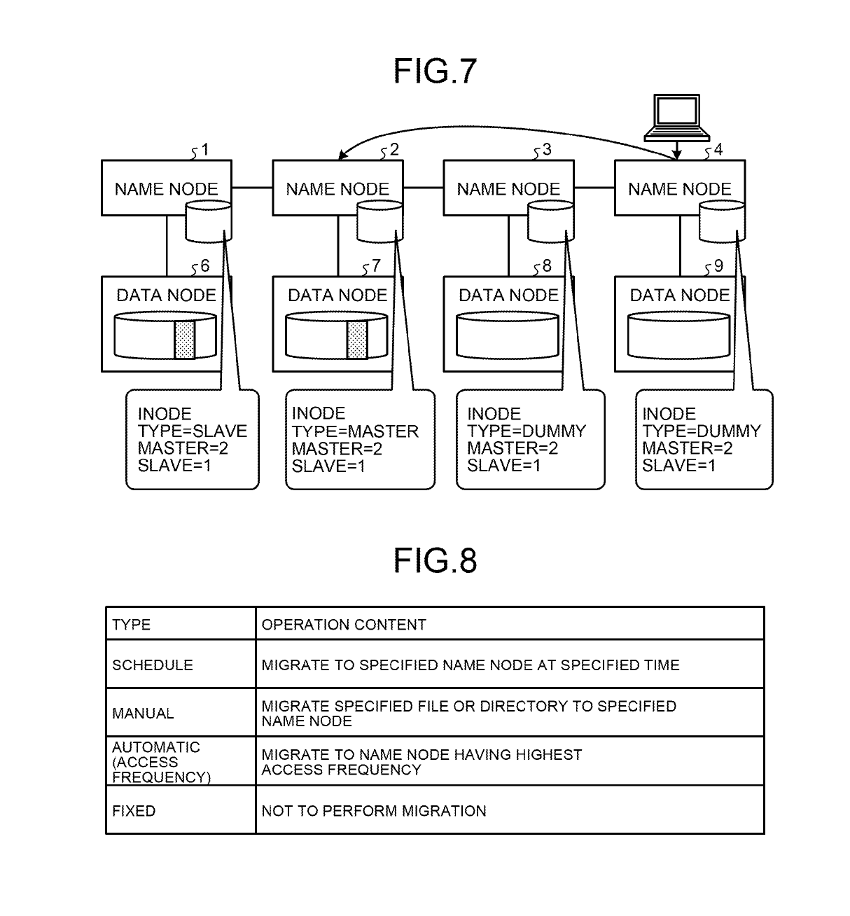

FIG. 7 is a diagram for explaining a process performed by the distributed file system 101 in response to a request for reading of a file to a dummy name node. FIG. 7 illustrates a case where a name node 4, which is a dummy name node, receives a file read request, and the name node 2 is a master of a file requested to be read out, and the name node 1 is a slave of the file requested to be read out. Furthermore, the name nodes 1 to 4 are connected to one another by a network.

As illustrated in FIG. 7, the name node 4 which has received the file read request is a dummy name node, so the name node 4 requests the name node 2, which is a master name node, to transfer the file. Then, the name node 4 transmits the file transferred from the name node 2 to a client. Incidentally, here, the master name node transfers the file to the dummy name node, and the dummy name node transfers the file to the client; however, the master name node can directly transmit the file to the client without transferring the file to the dummy name node.

The file writing unit 15 writes data specified in a file write request from a client to a specified file. When the name node 1 is a master of the file requested to write the data thereto, the file writing unit 15 writes the file in a data node of the name node 1, and instructs a slave name node to write the data to the file. On the other hand, when the name node 1 is not a master of the file requested to write the data thereto, the file writing unit 15 transfers the request to a master name node, and transmits a response to a requestor on the basis of a response from the master name node.

The file close unit 16 performs a process of completing input-output to a file specified in a file close request. When the name node 1 is a master of the file requested to be closed, the file close unit 16 performs the completing process on the file in a data node of the name node 1, and instructs a slave name node to close the file. On the other hand, when the name node 1 is not a master of the file requested to be closed, the file close unit 16 transfers the file close request to a master name node, and transmits a response to a requestor on the basis of a response from the master name node.

The file deleting unit 17 performs a process of deleting a file specified in a file delete request. When the name node 1 is a master of the file requested to be deleted, the file deleting unit 17 performs a process of deleting the file in the name node 1, and instructs a slave name node to delete the file. On the other hand, when the name node 1 is not a master of the file requested to be deleted, the file deleting unit 17 transfers the file delete request to a master name node, and transmits a response to a requestor on the basis of a response from the master name node.

The statistical processing unit 18 records log information including the number of accesses to a file from clients on the meta-information storage unit 10.

The migration unit 19 performs migration of a file on the basis of a migration policy. FIG. 8 is a diagram illustrating an example of a migration policy. As illustrated in FIG. 8, types of the migration policy include “schedule”, “manual”, “automatic”, and “fixed”.

“Schedule” indicates to perform migration on the basis of a schedule, and the migration unit 19 migrates a specified file or a specified directory to a specified name node at specified time. For example, when a file written in Tokyo is referenced or updated in London and is further referenced or updated in New York, by migrating the file regularly according to time difference, the distributed file system 101 can speed up the file access.

Incidentally, a migration schedule is shared by all name nodes, and migration is performed on the initiative of a master of each file. Name nodes which are not a master of a file ignore a migration schedule of the file.

“Manual” indicates to perform migration on the basis of an instruction from a system administrator, and the migration unit 19 migrates a specified file or directory to a specified name node.

“Automatic” indicates to perform migration on the basis of the access frequency, and the migration unit 19 migrates a file to a node having the highest access frequency. For example, after a file created in Tokyo has been referenced or updated in Tokyo for a given period of time, when the file is referenced in New York over a long period of time, by migrating the file on the basis of the access frequency, the distributed file system 101 can speed up the file access.

“Fixed” indicates not to perform migration. For example, if a file created in Tokyo is used in Tokyo only, the file requires no migration.

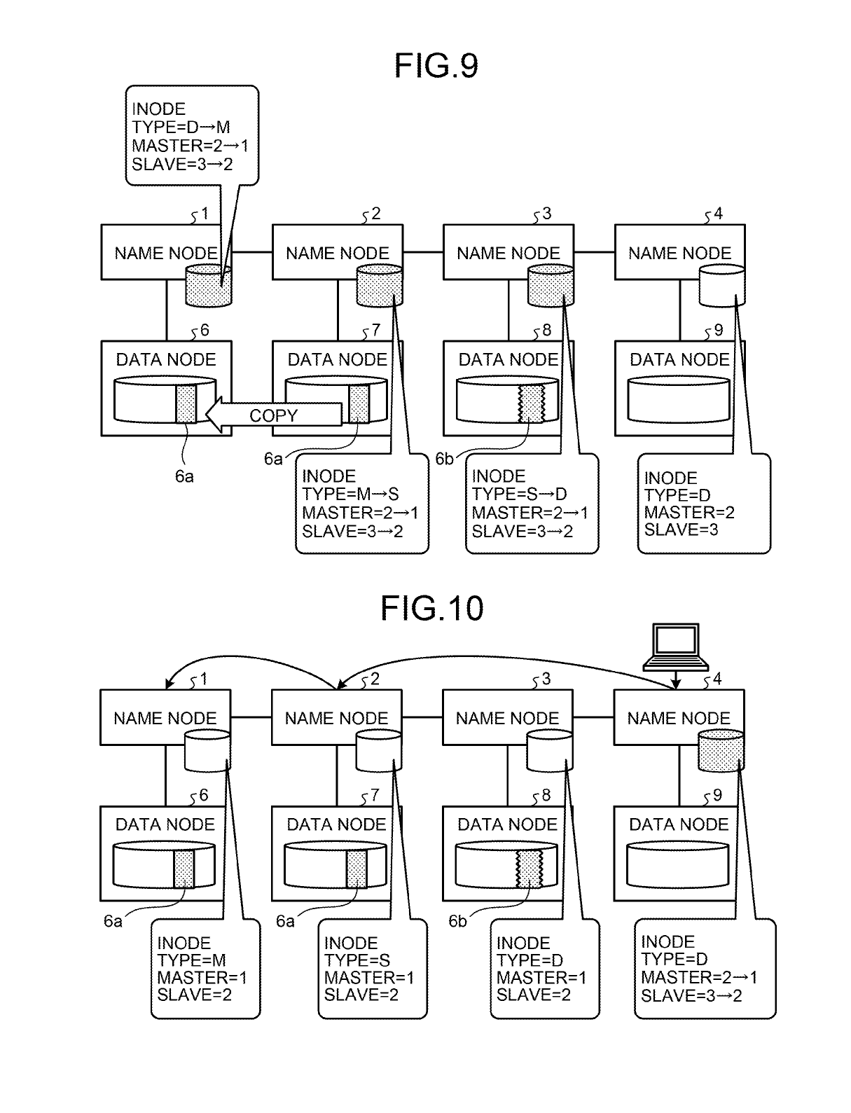

The migration unit 19 performs, as a migration process, copying of a file from a source to a migration destination and update of meta-information. FIG. 9 is a diagram for explaining the migration process. FIG. 9 illustrates a case in which in a state where a master name node is the name node 2, a slave name node is the name node 3, and the name nodes 1 and 4 are dummy name nodes, a file is migrated from the name node 2 to the name node 1.

In this case, as a migration process, the migration unit 19 of the name node 1 copies a file 6a from the name node 2 to the name node 1. Then, migration units of the name nodes 1 to 3 update meta-information of the file 6a.

Specifically, the migration unit 19 of the name node 1 updates type of the name node 1 from dummy (D) to master (M), and updates the master name node from the name node 2 to the name node 1, and updates the slave name node from the name node 3 to the name node 2. A migration unit of the name node 2 updates type of the name node 2 from master (M) to slave (S), and updates the master name node from the name node 2 to the name node 1, and updates the slave name node from the name node 3 to the name node 2. A migration unit of the name node 3 updates type of the name node 3 from slave (S) to dummy (D), and updates the master name node from the name node 2 to the name node 1, and updates the slave name node from the name node 3 to the name node 2.

Incidentally, as for the name node 4 which is a dummy name node both before and after the migration, traffic related to the migration does not occur. Therefore, the distributed file system 101 can reduce traffic among name nodes at the time of migration.

FIG. 10 is a diagram for explaining a process for reading of a file to a dummy name node after migration. FIG. 10 illustrates a case where after the migration illustrated in FIG. 9 and before resynchronization, the name node 4 has received a file read request from a client.

When the name node 4 has received the file read request, as the name node 4 is not a master, a file reading unit of the name node 4 transfers the read request to the name node 2 determined to be a master from meta-information. Incidentally, a master name node at this point is the name node 1; however, meta-information of the name node 4 has not been updated, so the file reading unit of the name node 4 determines that a master is the name node 2.

When the name node 2 has received the file read request, as the name node 2 is not a master, a file reading unit of the name node 2 transfers the read request to the name node 1 determined to be a master from meta-information. Then, the file reading unit 14 of the name node 1 reads out the file 6a from the data node 6, and transfer the file 6a together with meta-information to the name node 4. Then, the file reading unit of the name node 4 transmits the file 6a to the client, and updates the meta-information. That is, the file reading unit of the name node 4 updates the master name node of the file 6a transmitted to the client to the name node 1, and updates the slave name node of the file 6a transmitted to the client to the name node 2.

Incidentally, in FIGS. 9 and 10, as a result of the migration, the name node 3 has been changed from a slave name node to a dummy name node; however, an actual file 6b in the data node 8 is not deleted. Deletion of the actual file 6b is performed when a disk usage rate of the data node 8 exceeds a threshold value. The name node 3 holds a hash value of an actual file in an inode, and, when the name node 3 is changed from a dummy to a master or a slave again, the name node 3 skips copying of a file if a hash value of the file is the same.

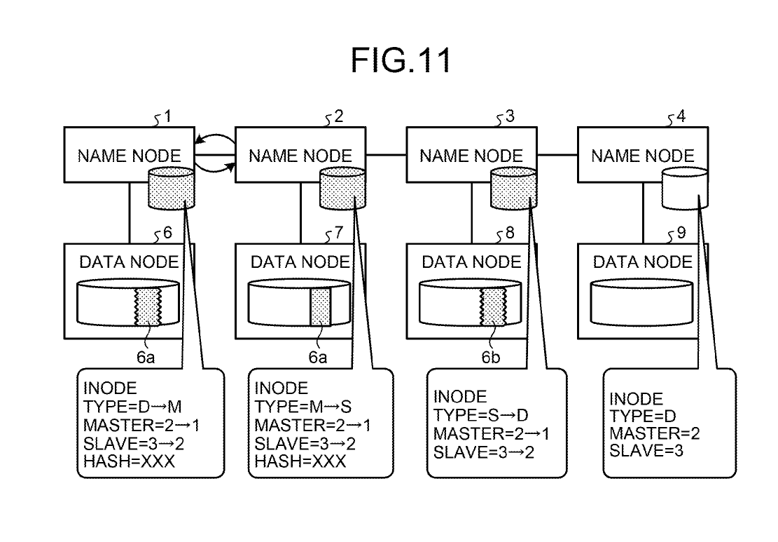

FIG. 11 is a diagram for explaining file-copying skipping based on a hash value. FIG. 11 illustrates a case where a master is changed from the name node 2 to the name node 1 as is the case in FIG. 9; however, there is already the file 6a in the data node 6 of the name node 1. In FIG. 11, a hash value of the file 6a in the data node 7 and a hash value of the file 6a in the data node 6 are both XXX, i.e., are the same value. Therefore, at the time of migration, the file 6a in the data node 6 is used as an actual file without copying of the file 6a in the data node 7 into the name node 1.

To return to FIG. 3, the communication unit 20 performs communication with another name node or a client. For example, the file creating unit 11 receives a file create request from a client via the communication unit 20, and issues an instruction to create a slave file via the communication unit 20. Furthermore, the resynchronization unit 12 transmits and receives meta-information via the communication unit 20.

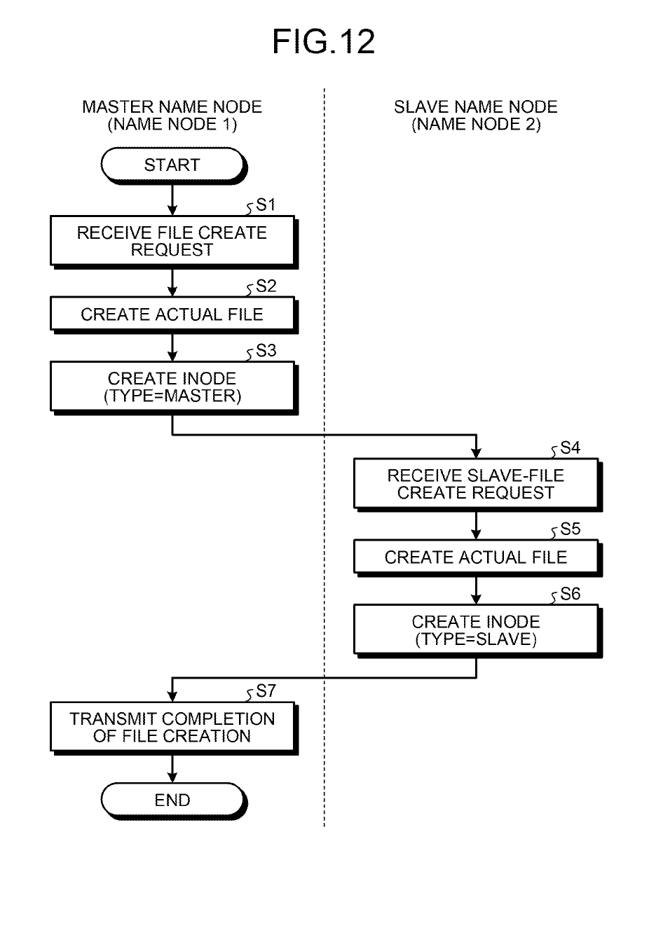

Subsequently, the flow of a file creating process is explained. FIG. 12 is a flowchart illustrating the flow of the file creating process. Incidentally, here, as an example, there is explained a case where the name node 1 receives a file create request from a client as illustrated in FIG. 5.

As illustrated in FIG. 12, the file creating unit 11 of the name node 1 receives a file create request from a client (Step S1), and creates an actual file in the data node 6 (Step S2). Then, the file creating unit 11 creates an inode indicating type=master (Step S3), and registers an inode number of the inode in the directory in a manner corresponding to a file name.

Then, the file creating unit 11 transmits a slave-file create request to the name node 2, and the name node 2 receives the slave-file create request (Step S4). Then, the file creating unit of the name node 2 creates an actual file (Step S5), and creates an inode indicating type=slave (Step S6).

Then, the file creating unit of the name node 2 transmits a response of completion of slave file creation to the name node 1, and the file creating unit 11 of the name node 1 transmits completion of file creation to the client (Step S7).

In this manner, when a file has been created, a master name node performs the synchronization process with only a slave name node, and does not perform the synchronization process with the other name node as a dummy name node; therefore, the distributed file system 101 can shorten the time taken to perform the synchronization process.

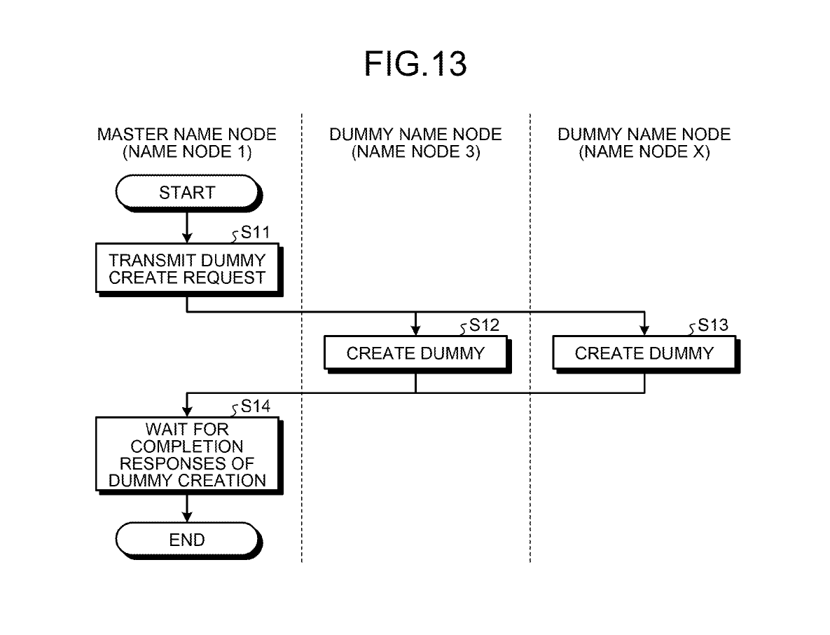

Subsequently, the flow of a resynchronization process is explained. FIG. 13 is a flowchart illustrating the flow of the resynchronization process. Incidentally, here, as an example, there is explained a case where the name node 1 is a master, the name nodes 3 and x are dummies.

As illustrated in FIG. 13, the resynchronization unit 12 of the name node 1, which is a master name node, transmits a dummy create request to dummy name nodes (Step S11). Then, resynchronization units of the name nodes 3 and x, which are dummy name nodes, each create a dummy (Steps S12 and S13).

Then, the resynchronization unit 12 of the name node 1 waits for completion responses of dummy creation from the dummy name nodes (Step S14), and, when having received the dummy creation responses from all the dummy name nodes, terminates the process.

In this manner, the resynchronization unit performs creation of a dummy asynchronously with file creation, thereby the distributed file system 101 can maintain the consistency of meta-information among multiple name nodes.

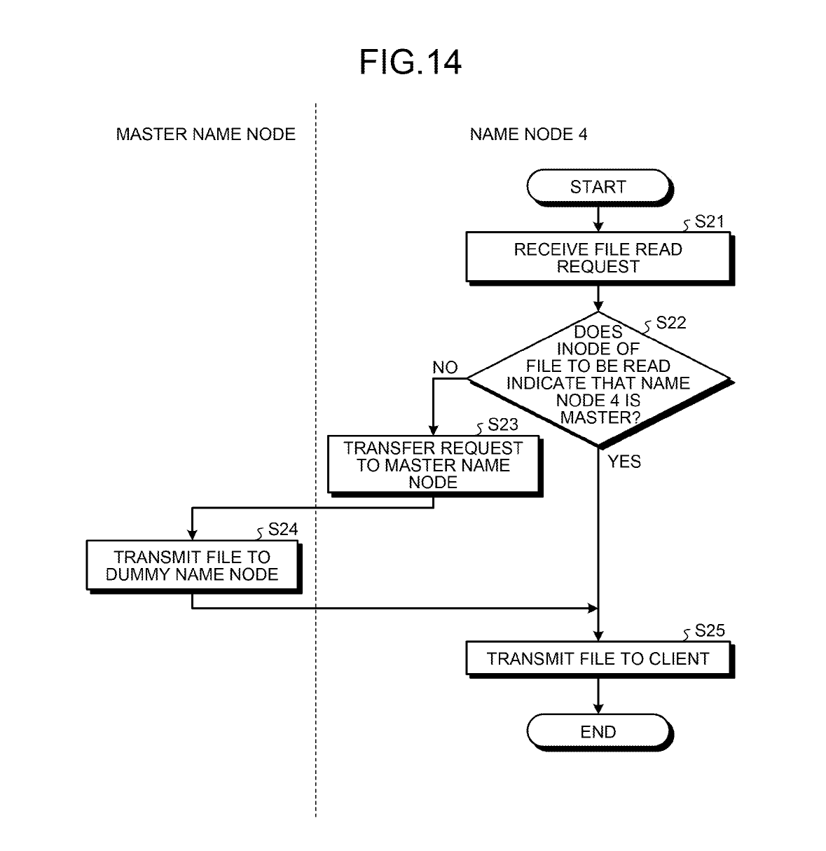

Subsequently, the flow of a file reading process is explained. FIG. 14 is a flowchart illustrating the flow of the file reading process. Incidentally, here, as an example, there is explained a case where the name node 4 receives a file read request from a client.

As illustrated in FIG. 14, the file reading unit of the name node 4 receives the file read request (Step S21), and determines whether the name node 4 is a master or not from an inode of a file to be read (Step S22). As a result, if the name node 4 is a master, the file reading unit reads out the file from a data node and transmits the read file to the client (Step S25).

On the other hand, if the name node 4 is not a master, the file reading unit transfers the read request to a master name node (Step S23). Then, a file reading unit of the master name node reads out the file from a data node and transmits the read file to a dummy name node, i.e., the name node 4 (Step S24). Then, the file reading unit of the name node 4 transmits the file to the client (Step S25).

In this manner, a dummy name node transfers a file read request to a master name node, and therefore can respond to a request for reading of a file that is not in a data node thereof. Incidentally, here, a dummy name node transfers a file read request to a master name node; however, the dummy name node can transfer the file read request to the master name node or a slave name node, whichever is closer to the dummy name node.

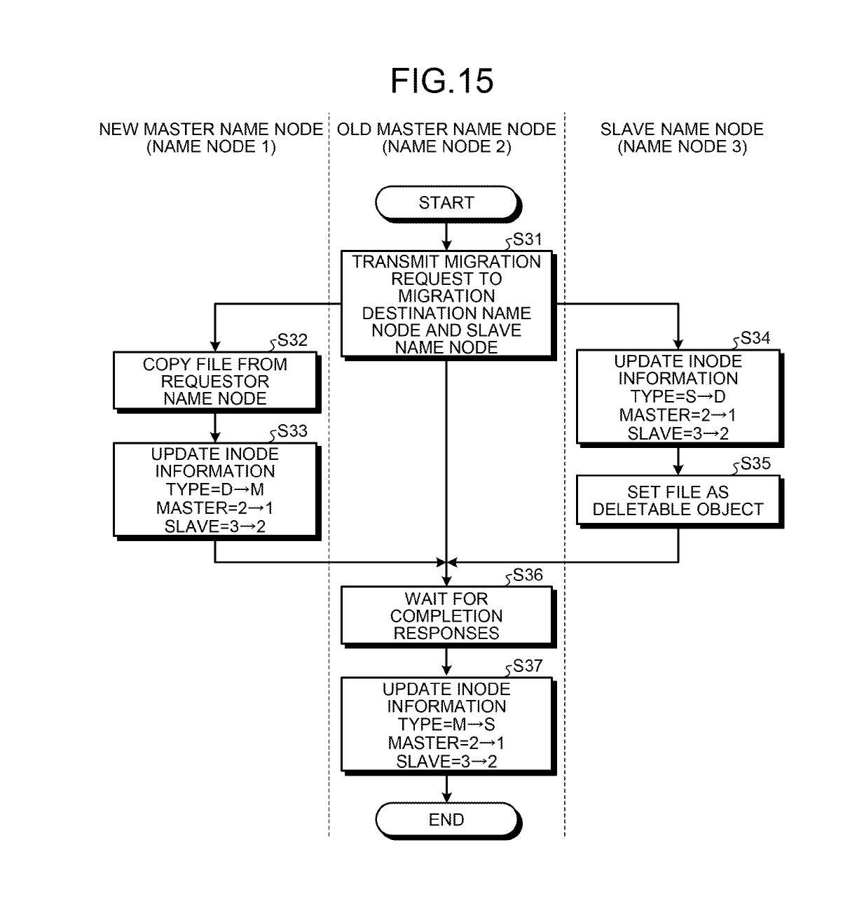

Subsequently, the flow of the migration process is explained. FIG. 15 is a flowchart illustrating the flow of the migration process. Incidentally, here, as an example, there is explained a case where a master is switched from the name node 2 to the name node 1 as illustrated in FIG. 9.

As illustrated in FIG. 15, the migration unit of the name node 2, which is a master name node before migration, transmits a migration request to a migration destination name node and a slave name node (Step S31).

Then, the migration unit 19 of the name node 1, which is a master name node after migration, copies a file from a requestor name node into the name node 1 (Step S32), and updates inode information (Step S33). As the update of the inode information, specifically, the migration unit 19 changes type of the name node 1 from dummy (D) to master (M), and changes the master name node from the name node 2 to the name node 1, and changes the slave node from the name node 3 to the name node 2.

Furthermore, the migration unit of the name node 3, which is a slave name node before migration, updates inode information (Step S34), and sets the file as a deletable object (Step S35). As the update of the inode information, specifically, the migration unit changes type of the name node 3 from slave (S) to dummy, and changes the master name node from the name node 2 to the name node 1, and changes the slave node from the name node 3 to the name node 2.

Then, the migration unit of the name node 2 waits for completion responses from the name nodes 1 and 3 (Step S36), and, when having received responses from both the name nodes 1 and 3, updates inode information (Step S37). Specifically, the migration unit of the name node 2 changes type of the name node 2 from master to slave, and changes the master name node from the name node 2 to the name node 1, and changes the slave node from the name node 3 to the name node 2.

In this manner, the migration unit does not transmit a migration request to any name nodes other than a new master name node and a slave node; therefore, the distributed file system 101 can shorten the time taken to perform the synchronization process.

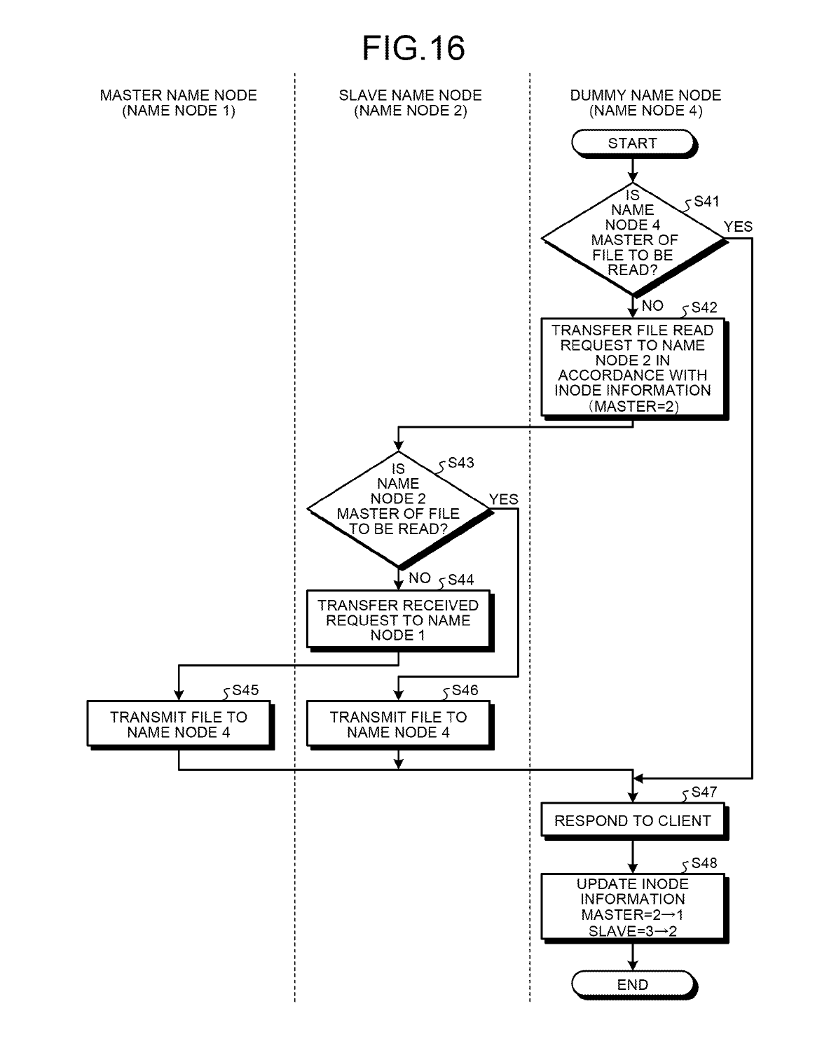

Subsequently, the flow of an after-migration file reading process is explained. FIG. 16 is a flowchart illustrating the flow of the after-migration file reading process. Incidentally, here, as an example, there is explained a case where the name node 4 receives a file read request from a client.

As illustrated in FIG. 16, when the name node 4 has received the file read request, the file reading unit of the name node 4 determines whether the name node 4 is a master of a file to be read (Step S41). As a result, if the name node 4 is a master, the file reading unit reads out the file from a data node, and the process control moves on to Step S47.

On the other hand, if the name node 4 is not a master, the file reading unit transfers the file read request to the name node 2 which is a master name node in accordance with inode information (Step S42). Then, the file reading unit of the name node 2 receives the file read request, and determines whether the name node 2 is a master of the file to be read (Step S43). As a result, if the name node 2 is a master, the file reading unit of the name node 2 reads out the file from a data node and transfers the read file to the name node 4 (Step S46). Then, the process control moves on to Step S47.

On the other hand, if the name node 2 is not a master, the file reading unit of the name node 2 transfers the file read request to a master name node (the name node 1 in this example) (Step S44). Here, the name node 2 is not a master, which means after a master name node has been switched from the name node 2 to the name node 1 and before resynchronization is performed, the name node 4 has received the file read request from the client.

Then, the file reading unit 14 of the name node 1 receives the file read request, and reads out the file from a data node and transfers the read file to the name node 4 (Step S45). Then, the process control moves on to Step S47.

Then, the file reading unit of the name node 4 transmits the file to the client (Step S47), and updates inode information (Step S48). Specifically, the file reading unit of the name node 4 changes the master name node from the name node 2 to the name node 1, and changes the slave node from the name node 3 to the name node 2.

In this manner, when a dummy name node has transferred a file read request to an old master name node based on old inode information before migration, the old master name node transfers the file read request to a new master name node. Therefore, a file can be transferred from the master name node to the dummy name node.

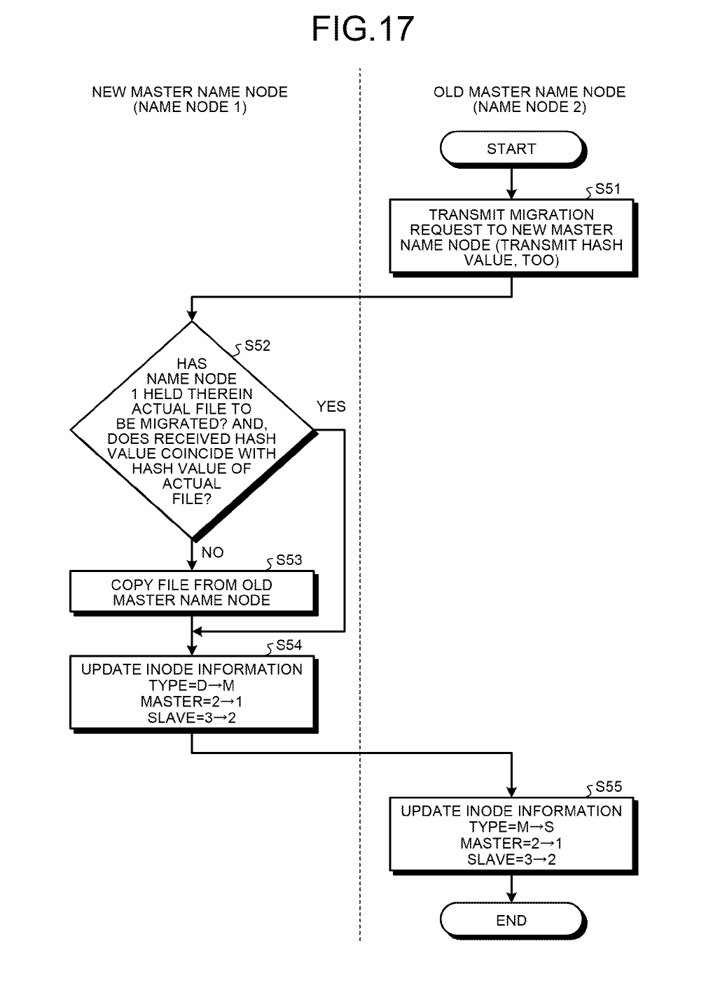

Subsequently, the flow of a master switching process using a hash value is explained. FIG. 17 is a flowchart illustrating the flow of the master switching process based on a hash value. Incidentally, here, as an example, there is explained a case where there is a file in the name node 1 to which a master is switched as illustrated in FIG. 11.

As illustrated in FIG. 17, the migration unit of the name node 2, which is a master name node before migration, transmits a migration request to a migration destination (Step S51). At this time, the migration unit of the name node 2 transmits a hash value of a file to be subject to migration, too. Incidentally, here, description of transmission of the migration request to a slave node is omitted.

The migration unit 19 of the name node 1, which is a master name node after migration, holds an actual file to be subject to migration, and determines whether the received hash value coincides with a hash value of the actual file held therein (Step S52). As a result, if the migration unit 19 has held therein an actual file to be subject to migration and the received hash value coincides with a hash value of the actual file held therein, the migration unit 19 skips copying of the file, and the process control moves on to Step S54. On the other hand, if the migration unit 19 has not held therein an actual file to be subject to migration or if the received hash value does not coincide with a hash value of the actual file held therein, the migration unit 19 copies the file from an old master name node (Step S53).

Then, the migration unit 19 updates inode information (Step S54). As the update of the inode information, specifically, the migration unit 19 changes type of the name node 1 from dummy to master, and changes the master name node from the name node 2 to the name node 1, and changes the slave node from the name node 3 to the name node 2.

Then, when having received a response from the name node 1, the migration unit of the name node 2 updates inode information (Step S55). Specifically, the migration unit of the name node 2 changes type of the name node 2 from master to slave, and changes the master name node from the name node 2 to the name node 1, and changes the slave node from the name node 3 to the name node 2.

In this manner, when the migration unit 19 holds an actual file to be subject to migration and a received hash value coincides with a hash value of the actual file held therein, the migration unit 19 skips copying of the file; therefore, it is possible to reduce the load of the master migration process.

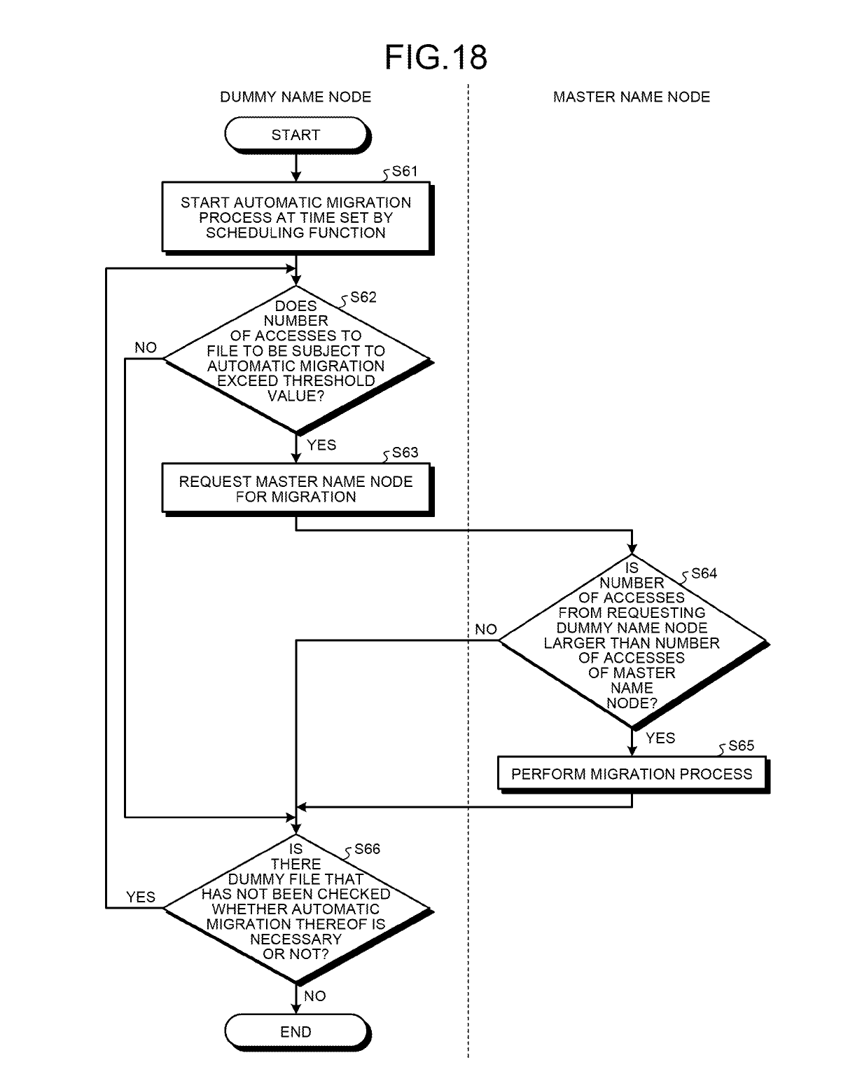

Subsequently, the flow of an automatic migration process based on access frequency is explained. FIG. 18 is a flowchart illustrating the flow of the automatic migration process based on access frequency.

As illustrated in FIG. 18, a migration unit of a dummy name node is activated at the time set by a scheduling function of the name node (Step S61). The activated migration unit determines whether the number of accesses to a file to be subject to automatic migration exceeds a threshold value (Step S62). As a result, if the number of accesses to the file does not exceed the threshold value, the process control moves on to Step S66.

On the other hand, if the number of accesses to the file exceeds the threshold value, the migration unit requests a master for migration (Step S63). Then, a migration unit of the master name node determines whether the number of accesses from the requesting dummy name node is larger than the number of accesses of the master name node (Step S64), and, if the number of accesses from the requesting dummy name node is larger, the migration unit of the master name node performs a migration process illustrated in FIG. 15 (Step S65).

Then, the migration unit of the dummy name node determines whether there is a dummy file that has not been checked whether automatic migration thereof is necessary or not (Step S66), and, if there is, the process control returns to Step S62; if there isn't, the process is terminated.

In this manner, the migration unit performs an automatic migration process, thereby a file can be migrated to an area having a high access frequency, and the distributed file system 101 can speed up access to the file.

As described above, in the embodiment, at the time of file creation, a master name node performs synchronization of meta-information with only a slave name node, and does not perform the meta-information synchronization with a dummy name node. The master name node performs the meta-information synchronization with the dummy name node asynchronously with file creation. Therefore, the distributed file system 101 can shorten the time required for meta-information synchronization performed among name nodes.

Furthermore, in the embodiment, the same meta-information as that stored in the master name node is stored in the slave name node, and a file is stored in a data node placed in the same node as the slave name node and a data node placed in the same node as the master name node. Therefore, the distributed file system 101 can provide a highly-reliable file system.

Moreover, in the embodiment, a migration unit of the master name node transmits a migration request to a dummy name node which is a migration destination, and the dummy name node which has received the migration destination becomes a master name node of a file to be subject to migration. Therefore, when the same file is accessed from multiple areas among which there are time differences, an area in which the file is stored is migrated according to time difference; therefore, the distributed file system 101 can speed up access to the file.

Furthermore, in the embodiment, a migration unit of the migration destination determines the presence or absence of a file to be subject to migration, and, if the migration destination has the file, the migration unit does not copy the file from a migration source. Therefore, the distributed file system 101 can shorten the time required for a migration process.

Moreover, in the embodiment, at scheduled time, a migration unit of the dummy name node determines whether the number of accesses to a file to be subject to automatic migration exceeds a predetermined threshold value, and, if it exceeds the predetermined threshold value, transmits a migration request to the master name node. Therefore, the distributed file system 101 can place the file in a node having a high access frequency, and can speed up access to the file.

Incidentally, in the embodiment, name nodes are discussed; however, components of a name node can be realized by software, thereby a name management program having the same functions as a name node can be obtained. A computer that executes the name management program is explained below.

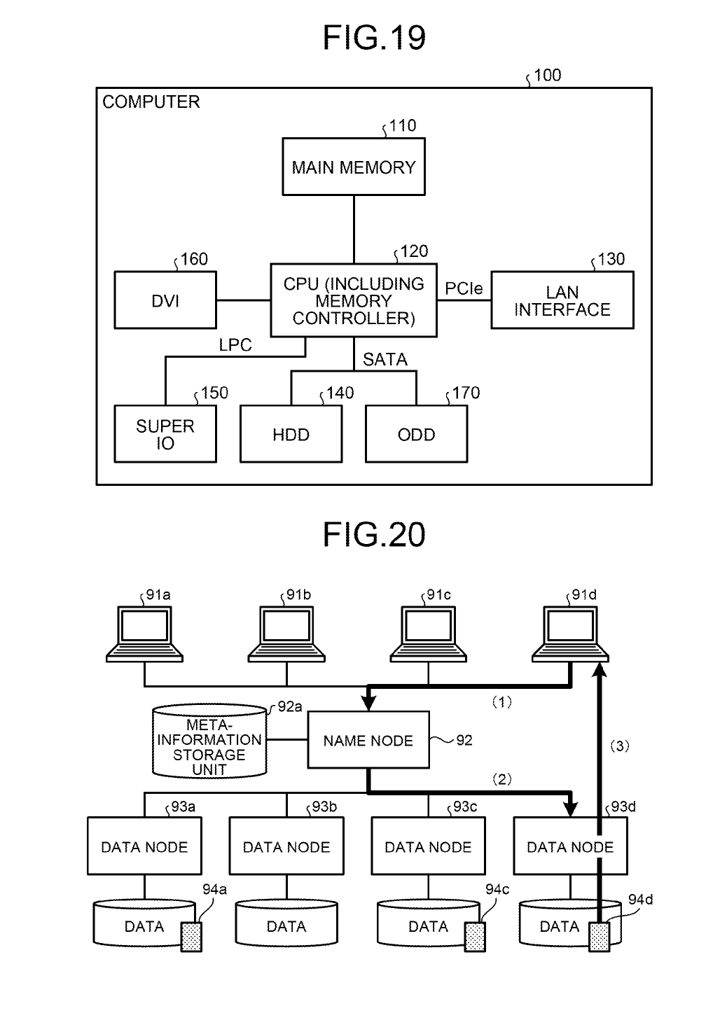

FIG. 19 is a diagram illustrating a hardware configuration of the computer that executes the name management program according to the embodiment. As illustrated in FIG. 19, a computer 100 includes a main memory 110, a central processing unit (CPU) 120, a local area network (LAN) interface 130, and a hard disk drive (HDD) 140. Furthermore, the computer 100 includes a super input/output (IO) 150, a digital visual interface (DVI) 160, and an optical disk drive (ODD) 170.

The main memory 110 is a memory that stores therein a program and an intermediate result of execution of the program, etc. The CPU 120 is a central processor that reads out the program from the main memory 110 and executes the program. The CPU 120 includes a chip set having a memory controller.

The LAN interface 130 is an interface for connecting the computer 100 to another computer via a LAN. The HDD 140 is a disk device that stores therein a program and data, and the super IO 150 is an interface for connecting input devices such as a mouse and a keyboard to the computer 100. The DVI 160 is an interface for connecting a liquid crystal display device to the computer 100, and the ODD 170 is a device that performs reading and writing to a DVD.

The LAN interface 130 is connected to the CPU 120 by PCI Express (PCIe), and the HDD 140 and the ODD 170 are connected to the CPU 120 by SATA (Serial Advanced Technology Attachment). The super IO 150 is connected to the CPU 120 by LPC (Low Pin Count).

The name management program executed by the computer 100 is stored on a DVD, and is read out from the DVD by the ODD 170 and installed on the computer 100. Or, the name management program is stored in a database of another computer connected to the computer 100 via the LAN interface 130, and is read out from the database and installed on the computer 100. Then, the installed name management program is stored in the HDD 140, and is read into the main memory 110 and executed by the CPU 120.

Furthermore, in the embodiment, there is described the case where a data node stores therein a file; however, the present invention is not limited to this, and can be also applied to a case where a data node stores therein another form of data.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage system in which multiple nodes that each include a storage device and a management device are connected by a network, the storage system comprising:
a first management device, out of multiple management devices, that stores, when data has been created, the data in a storage device in a node thereof, and manages an identifier of the data in a manner associated with a storage location of the data in the storage device; and
a second management device that receives an instruction to associate information indicating that the data is under the management of the first management device with the identifier of the data from the first management device asynchronously with the time of creation of the data, and manages the information in a manner associated with the identifier.

2. The storage system according to claim 1, further comprising a third management device, out of the multiple management devices, that stores, when the data has been created, the data in a storage device in a node thereof on the basis of an instruction from the first management device, and manages the identifier of the data in a manner associated with a storage location of the data in the storage device.

3. The storage system according to claim 2, wherein
the second management device receives a migration instruction to migrate the data to the second management device from the first management device, and stores the data in a storage device in a node thereof, and manages the identifier of the data in a manner associated with a storage location of the data in the storage device, and
the third management device receives the migration instruction from the first management device, and manages information indicating that the data is under the management of the second management device in a manner associated with the identifier of the data.

4. The storage system according to claim 3, wherein
when the first management device has received an migration instruction to migrate the data to the first management device from the second management device, the first management device determines whether data stored in the storage device in the node thereof is able to be used, and, only when the stored data is unable to be used, receives the data from the second management device.

5. The storage system according to claim 1, wherein
the second management device records the number of accesses to the data, and, when the number of accesses exceeds a predetermined threshold value, requests the first management device for migration of the data.

6. A storage control device that constructs a node together with a storage device in a storage system in which multiple nodes are connected by a network, the storage control device comprising:
a receiving unit that receives an instruction to associate information indicating that data is under the management of another storage control device with an identifier of the data from the another storage control device asynchronously with the time of creation of the data; and
a synchronizing unit that stores data management information in which the information is associated with the identifier on the basis of the instruction in a storage unit, and synchronizes the data management information related to the identifier of the data with the another storage control device.

7. A non-transitory computer-readable storage medium having stored therein a control program executed by a computer embedded in a management device that constructs a node together with a storage device in a storage system in which multiple nodes are connected by a network, the control program causing the computer to execute a process comprising:
receiving an instruction to associate information indicating that data is under the management of another management device with an identifier of the data from the another management device asynchronously with the time of creation of the data; and
storing data management information in which the information is associated with the identifier on the basis of the instruction in a storage unit.
